(19) United States
(12) Patent Application Publication
(10) Pub. No.: US 2026/0147804 A1
(43) Pub. Date: May 28, 2026

(54) SYSTEM(S), METHOD(S) AND APPARATUS FOR JOINTLY PERFORMING RETRIEVAL AUGMENTED GENERATION AND AI MODEL FINE-TUNING

(71) Applicant: Intel Corporation, Santa Clara, CA (US)

(72) Inventors: Xia Zhu, Portland, OR (US); Jianfang Zhu, Washougal, WA (US); Sudhir Tonse Udupa, Folsom, CA (US)

(73) Assignee: Intel Corporation, Santa Clara, CA (US)

(21) Appl. No.: 19/408,003

(22) Filed: Dec. 3, 2025

Related U.S. Application Data
(60) Provisional application No. 63/845,895, filed on Jul. 17, 2025.

(51) Int. Cl. G06F 16/3329; G06N 20/00

(52) U.S. Cl. CPC G06F 16/33295; G06N 20/00

(57) ABSTRACT

Disclosed systems and methods optimize retrieval augmented generation (RAG) pipelines and AI model fine-tuning through bidirectional feedback integration. During RAG operations, question-answer (QA) and question-context (QC) pairs are automatically generated from document ingestion and user feedback, then expert-verified for quality assurance. Accumulated verified QA pairs fine-tune large language models (LLMs), while QC pairs fine-tune embedding and re-ranker models when predefined thresholds are met. Fine-tuned models exceeding performance thresholds replace corresponding RAG pipeline components. Successfully encoded training data is optionally removed from vector databases, reducing storage requirements and retrieval latency. This disclosed method may include low-rank adaptation (LoRA) to enable low bit (e.g., INT4) operations without accuracy degradation. RAG operations generate high-quality training data to address fine-tuning's data acquisition challenge, while fine-tuned models reduce RAG's resource requirements.

### RELATED APPLICATION

This patent claims the benefit of U.S. Provisional Patent Application No. 63/845,895, which was filed on Jul. 17, 2025. U.S. Provisional Patent Application No. 63/845,895 is hereby incorporated herein by reference in its entirety. Priority to U.S. Provisional Patent Application No. 63/845,895 is hereby claimed.

### BACKGROUND

In recent years, the deployment and commercial adoption of large language models (LLMs) have seen a marked increase across diverse industries. LLMs are able to generate text and perform complex language-based tasks with high accuracy. These models, typically based on transformer architectures, are trained on large bodies of text and can generate natural language text in response to user input. In a standard use case, a user provides a prompt (such as a question, instruction, or sentence), which the model interprets based on learned statistical patterns in language. The model then generates a response, often completing tasks ranging from summarization and translation to code generation and conversational dialogue. The output is generated based on the model's internal parameters, which encapsulate knowledge encoded during training.

### BRIEF DESCRIPTION OF THE DRAWINGS

FIG. 1 is a block diagram of an example architecture for joint Retrieval Augmented Generation (RAG) and fine-tuning of a machine learning model.

FIGS. 2-5 illustrate example prompts for extracting Question-Answer (QA) and/or Question-Context (QC) pairs from documents.

FIG. 6 is a block diagram of an example implementation of a model fine-tuning system.

FIG. 7 is a flowchart representative of example machine readable instructions and/or example operations that may be executed, instantiated, and/or performed by example programmable circuitry to implement the model fine-tuning system of FIG. 6 to generate QA and/or QC pairs based on user documents.

FIG. 8 is a flowchart representative of example machine readable instructions and/or example operations that may be executed, instantiated, and/or performed by example programmable circuitry to implement the model fine-tuning system of FIG. 6 to generate QA and/or QC pairs while responding to a user query.

FIG. 9 is a flowchart representative of example machine readable instructions and/or example operations that may be executed, instantiated, and/or performed by example programmable circuitry to implement the model fine-tuning system of FIG. 6 to perform fine-tuning of a machine learning model based on QA & QC pairs.

FIG. 10 is a block diagram of an example processing platform including programmable circuitry structured to execute, instantiate, and/or perform the example machine readable instructions and/or perform the example operations of FIGS. 7-9 to implement the fine-tuning system of FIG. 6.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Large language models (LLMs) have inherent limitations. An example limitation of LLMs is a knowledge cutoff. LLMs are typically trained on massive datasets, but these datasets have a cutoff date. This means LLMs lack knowledge of recent events or constantly evolving information. LLMs are also prone to hallucination, where the LLM generates plausible sounding, but factually incorrect, responses to prompts. LLMs may also lack domain-specific knowledge. For example, while LLMs have broad knowledge, specific knowledge required for certain domains (e.g., legal, medical, financial) might not be present. In some examples, LLMs may have an inability to access private or internal data. For example, LLMs generally cannot access an organization's internal data without specific configurations.

To address these limitations, a notable advancement is the integration of Retrieval-Augmented Generation (RAG), a technique that allows models to dynamically access external knowledge sources during inference (e.g., when processing a prompt). This augmentation enhances factual accuracy, expands the model's contextual scope, and mitigates the limitations of static training data. Fine-tuning of models may also be used, where a model (e.g., a foundational model) is further trained based on local and/or use-case-specific information. While base LLMs (e.g., foundational models) are pretrained on broad datasets to capture general language patterns, fine-tuning involves additional training on a narrower, task-specific dataset, allowing the model to specialize in areas such as legal reasoning, medical diagnostics, customer support, or code synthesis. This fine-tuning process adjusts the model's internal weights through supervised learning, reinforcement learning, and/or newer parameter-efficient methods such as Low-Rank Adaptation (LoRA) or prompt tuning. Fine-tuning improves model performance by aligning outputs with domain-specific knowledge, tone, or regulatory requirements, and can also be used to reduce undesirable behaviors or biases. In enterprise or regulated environments, fine-tuning enables the deployment of LLMs that meet stringent accuracy, safety, and compliance standards, thereby enhancing both commercial value and operational trust in AI systems.

While RAG provides LLMs with access to external knowledge, thereby allowing the LLM to be more accurate and up to date than if there were no access to external knowledge, RAG also comes with resource constraints. For example, RAG data sources (e.g., databases, file shares, repositories, etc.) can consume data storage resources. Further, there are additional computational and/or communication costs associated with accessing and/or processing data stored in the RAG data sources. In some examples, LLMs can be used in a variety of settings, including in personal assistant devices. Such implementations may operate based on a user's unique data and provide personalized suggestions and/or responses for a user. As a result, data might be personal and/or local to a user computing system, and not be accessible outside of that system.

As used herein, a user is defined to be any entity that initiates, receives, or otherwise interacts with the LLM system(s). A user therefore includes one or more human operators (e.g., accessing the system through a user interface (UI)), and/or one or more non-human entities such as software agents, automated scripts, web services, or any programmatic interface that submits queries (e.g., prompts) to or receives responses from the retrieval-augmented generation and fine-tuning pipeline disclosed herein. Where appropriate, the term human user will be used to identify humans who are users and the term non-human user will be used to refer to one or more machines functioning as a user.

Fine-tuning improves (e.g., optimizes) LLMs for specific tasks and datasets, improving their performance and customization. One of the biggest challenges of fine-tuning is acquisition of high quality training data. Organizations may frequently not pursue fine-tuning efforts because of the cost of generating high-quality training data.

Examples disclosed herein enable creation of training data as part of the RAG pipeline, thereby improving fine-tuning efforts. Fine-tuning efforts can then be leveraged to enhance RAG operations. For example, once it is determined that information obtained via RAG has been sufficiently included in the trained model, such information is no longer needed to be stored in a vector database that is accessed using RAG. Such information is then removed from the vector database, improving RAG efficiency.

With examples disclosed herein, high quality training data can be generated for fine-tuning by leveraging the RAG pipeline and/or user feedback. In this manner, examples disclosed herein builds this pool of “high-quality training data” by first having the system answer a prompt (e.g., a user question) and turning that answer into a learning example. When an answer to a question is retrieved from the vector database, the answer is paired with the passages that were used to generate the answer, creating a question-answer pair. In some examples, question-context (QC) pairs may also be generated. These pairs can then be presented to a user (human or machine) for approval or disapproval. Such pairs are stored in a training-data repository. As more questions are answered and more approvals accumulate, the system gathers a large set of reliable question-answer (QA) and/or question-context (QC) pairs. These collected pairs (each verified by a user and linked to the exact passages that produced the answer) represent high-quality data that can be fed into the model for fine-tuning. AI models can then be fine-tuned with the acquired high-quality data. Once the evaluation accuracy of fine-tuned AI models is higher than a predefined threshold, the LLM model, embedding model, and/or re-ranker model used in the RAG pipeline can be updated accordingly, thereby improving the overall RAG accuracy.

As used herein, a question-answer (QA) pair is a data element that includes a question (e.g., a user-supplied prompt or a query), and a corresponding answer (e.g., a natural-language response produced by the large-language-model (LLM) when the question is presented together with the relevant context retrieved from the system's vector database). The answer may be the LLM's output during a Retrieval-Augmented Generation (RAG) operation or a response subsequently generated for fine-tuning purposes. A QA pair may also include a reference to the specific passages or embeddings that supported the answer. The QA pair can be created automatically by the system, presented to a user (e.g., a human user or a non-human user) for approval or rejection, and, once approved, stored in a fine-tuning data repository for use in training or fine-tuning the LLM, embedding, or re-ranking models that comprise the RAG pipeline.

As used herein, a question-context (QC) pair is a data element that includes a question (e.g., a user-supplied prompt or a query), and contextual information, which is a contiguous excerpt (or set of excerpts) of a source document(s) and/or a vector-embedded representation that the system has retrieved from its vector database. The context provides background information (e.g., contextual information) relevant to answering the question. The context portion of a QC pair may be the same passages that were used to generate an answer in a Retrieval-Augmented Generation (RAG) operation, or may be a specifically extracted segment that the system has identified as most pertinent to the question. QC pairs can be generated automatically by the system during RAG execution or by the system's fine-tuning data-generation circuitry, and may be presented to a user (e.g., a human user or a non-human user) for approval or rejection. Approved QC pairs are stored in a fine-tuning data repository and used as training data for fine-tuning embedding and re-ranking models within the RAG pipeline.

As used herein, an embedding model is a computational component that transforms text (such as a document fragment, a query, a prompt, an answer, etc.) into a numeric vector (a series of numbers) that captures the semantic meaning of that text. The resulting vector can be stored in the system's vector database and compared to other vectors to find the most similar passages. The embedding model is therefore the bridge that allows the system to convert raw language into a form that can be searched and compared quickly. The embedding model is trained initially on a vast body of text to capture general language patterns, but can later be fine-tuned by contrasting question-context pairs. For each question, the passage that truly answers the question is treated as a positive example while irrelevant passages serve as negative examples, guiding the embedding model to pull relevant vectors closer together. During fine-tuning only a small set of adapter parameters are updated, allowing the model to retain its broad linguistic knowledge while becoming more tuned to the specific documents and query types used by the system.

A re-ranking model is a computational component that receives a list of candidate passages (referred to herein as “chunks”) that have already been identified as potentially relevant by an initial retrieval step. Using a more sophisticated similarity calculation (sometimes involving a deep neural network that processes the query and each candidate together,) the re-ranking model assigns a relevance score to each candidate to facilitate identification of the most relevant candidates. The top passages may then be fed into the large-language-model together with the user query, ensuring that the LLM receives the most contextually relevant information for generation of a response.

In the Retrieval-Augmented Generation pipeline, the embedding model first creates vector representations of all stored documents and user queries, enabling approximate nearest-neighbor search. The re-ranking model then refines the initial search results by evaluating each candidate in the context of the query, producing a high-precision set of passages that are supplied to the large-language-model for final answer generation.

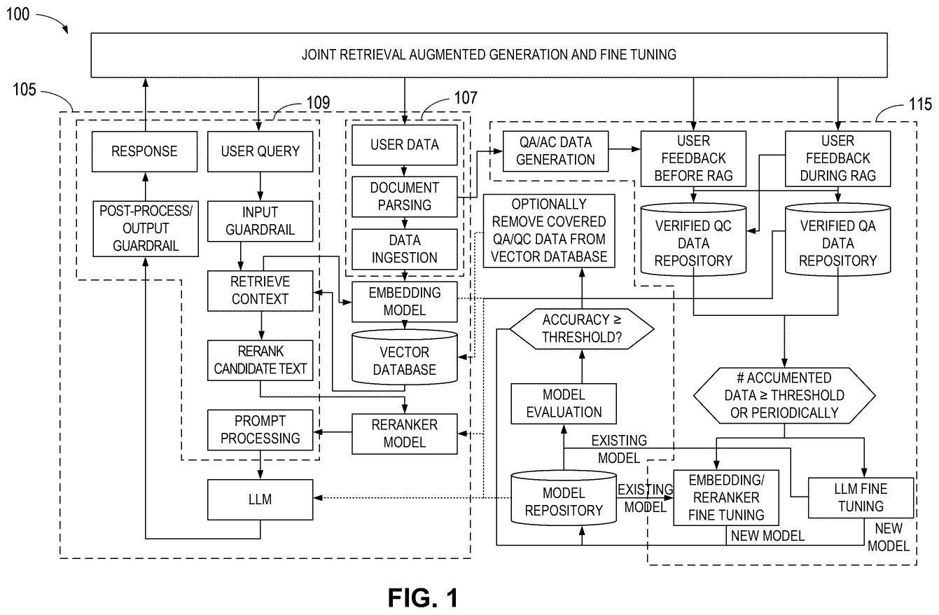

FIG. 1 is a block diagram of an example architecture 100 for joint Retrieval Augmented Generation (RAG) and fine-tuning of a machine learning model. The example diagram of FIG. 1 illustrates a RAG pipeline 105. In the illustrated example of FIG. 1, the RAG pipeline 105 is a two-level retrieval augmented generation (RAG) pipeline. In this example, the two-level RAG pipeline uses a re-ranking stage after initial retrieval of items for inclusion in a context. However, example approaches disclosed herein also work for one-level RAG pipelines as well (e.g., without re-ranking). The two-level RAG pipeline of FIG. 1 aims to improve the precision and relevance of retrieved information before it's fed to a Large Language Model (LLM). This multi-stage retrieval process helps to narrow down the context and provide the LLM with the most pertinent data.

The RAG pipeline 105 begins with user data ingestion. Raw data is parsed, cleaned, and organized (e.g., transformed) into a structured, searchable format. This process may involve normalizing the text, extracting information, and adding/extracting metadata. Next, the system creates embeddings by converting each text chunk into a numeric vector (an embedding), which is then stored into a database or storage system for later retrieval of relevant information.

The online phase of RAG 109 starts with one or more user queries or prompts. In some examples, a user query goes through a configurable input guardrail check to filter unsafe questions or inappropriate requests. Once it clears the guard rail, the query is transformed into an embedding (i.e., a numeric vector that captures the meaning of the query) by the embedding model. The embedding is then compared to the vectors stored in the vector database, allowing the system to quickly find a broad set of potentially relevant documents in a coarse-grained retrieval stage. A subsequent fine-grained retrieval stage analyzes those documents more deeply using techniques such as cross-encoder re-ranking, contextual analysis, and query expansion to identify the most precise and relevant information. After fine-grained retrieval, the system merges the retrieved passages with the original user query and a system prompt. The system prompt is an instruction (e.g., a pre-defined instruction) or background text that tells the large-language-model (LLM) how to frame the answer (for example, specifying tone, style, or domain constraints). The LLM then produces a response based on this augmented context, which is the combination of the user query, the system prompt, and the retrieved passages. In some examples, the response is then subjected to a configurable output guard-rail before being returned to the user.

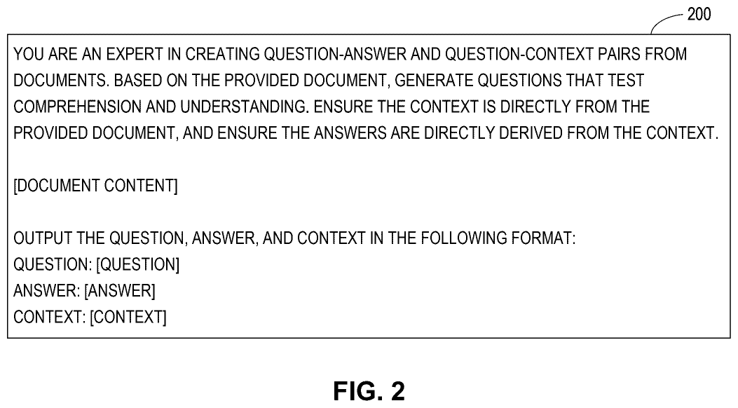

In the system illustrated in FIG. 1, documents that a user submits may be ingested independently of any query that a user (e.g., an agent) might issue. Once a document has been parsed and stored, the system can generate question-answer (QA) and question-context (QC) pairs directly from that document, without waiting for a user query. One or more large-language models perform this generation, using prompts that are described below in connection with FIGS. 2-5. Those example prompts of FIGS. 2-5 specify one or more factors to be used when generating a QA or QC pair (e.g., the need for key facts, a particular question type, or a limit on answer length). Those factors can be applied independently and/or in combination, allowing the system to create a diverse and richly-specified set of QA/QC examples that are subsequently used for fine-tuning the models.

FIG. 2 illustrates an example prompt 200 that instructs the model to produce basic question-answer and question-context pairs from a document. For every question generated, the model supplies a concise answer that is taken directly from the document and the exact excerpt of text that contains the answer. No extra constraints are imposed in the illustrated example of FIG. 2, so the resulting pairs capture the factual content of the document in a straightforward, unambiguous format.

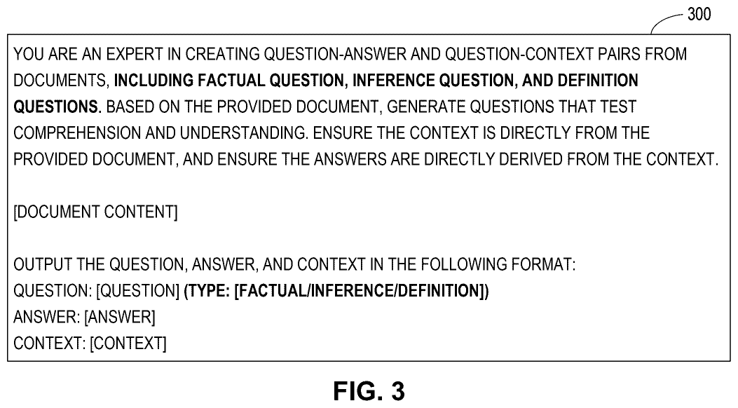

FIG. 3 illustrates an example prompt 300 which, in addition to the basic QA/QC structure of FIG. 2, requests the model to label each question with its type (e.g., FACTUAL, INFERENCE, or DEFINITION). This annotation enables downstream systems to distinguish between simple fact-retrieval questions, questions that demand reasoning, and questions that request definitions.

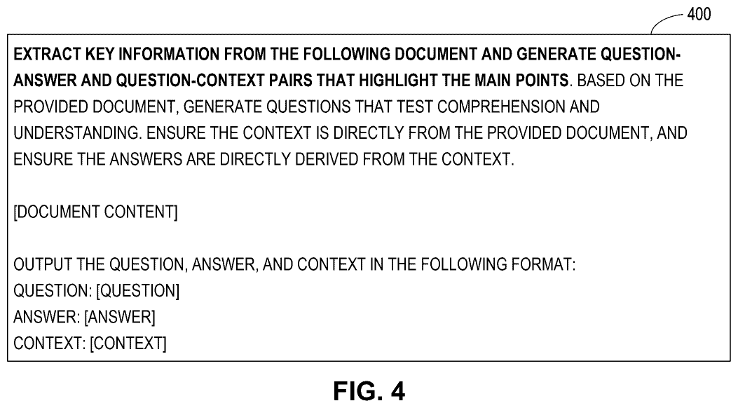

FIG. 4 illustrates an example prompt 400 that directs the model to surface the most important points of a document. The example prompt 400 requests generation of questions that highlight main ideas or critical facts within a document, while still providing the full answer and the relevant context excerpt. The emphasis in the example of FIG. 4 is on capturing key take-aways from the document, rather than every detail.

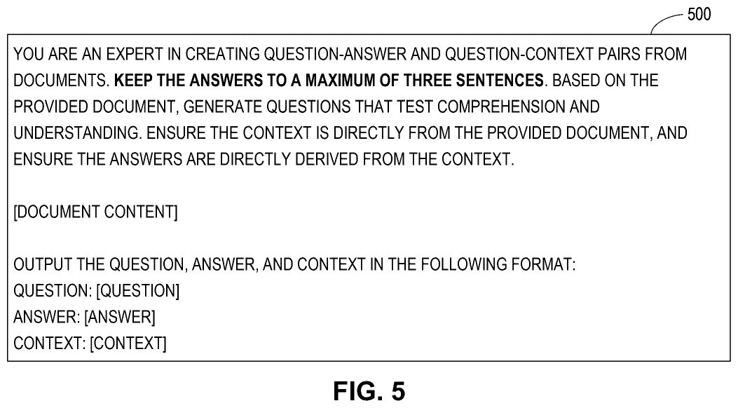

FIG. 5 illustrates an example prompt 500 in which the model is instructed to keep each answer to a maximum of three sentences. However, other maximum lengths may additionally or alternatively be used. This constraint yields concise, tightly-bounded responses, which are useful for training a model to produce short, precise answers.

Each prompt in FIGS. 2-5 supplies various permutations of training data (e.g., basic QA/QC pairs, question-type tagging, emphasis on key information, answer-length limitation, etc.). These permutations can be used independently or combined to create a richer, more varied dataset that better trains the model to handle diverse question types, prioritize critical facts, and/or deliver succinct answers. Returning to FIG. 1, in some examples, QA and QC pairs may be generated (e.g., by causing execution of the prompts of FIGS. 2, 3, 4, and/or 5) during execution of RAG. For example, during RAG execution, a user (e.g., a human user acting as a subject matter expert) can provide real-time feedback on the accuracy of responses. If an answer is found to be incorrect, the answer can be immediately flagged for correction (e.g., removal from a training data set). This feedback mechanism ensures that the overall pipeline continuously learns and improves. In some examples, once a user provides feedback (e.g., positive feedback confirming that the question and answer pair is correct, relevant, etc.), the corresponding question answer pair and/or question context pair (if any) are saved.

In examples disclosed herein, the QA and QC pairs that are generated by the RAG pipeline can be routed to an expert for verification before they are committed to the fine-tuning data store. An expert can be a human (e.g., a domain specialist who reviews the pair on a graphical user interface (GUI) or in a spreadsheet and marks it as “approved,” or “rejected”.) Alternatively, an expert can be a machine (e.g., a secondary, rule-based classifier or supervised classifier) that evaluates each pair against a set of predefined quality metrics (e.g., answer length, factual consistency, or semantic relevance). The human approach offers nuanced judgment and the ability to handle ambiguous or context-dependent cases, but may be is slower and more costly. In contrast, the machine approach scales rapidly, can process thousands of pairs per second, and is deterministic, but it may miss subtle errors that a human would catch. Regardless of the expert type, once a QA or QC pair receives a positive verdict, the pair is written to the fine-tuning data repository and becomes part of the training set for subsequent model updates. During execution of the RAG pipeline, the system creates question-answer (QA) and question-context (QC) pairs. In some examples, these pairs are passed through the embedding model to produce numeric vectors, which are then stored in the RAG pipeline's vector database. When a user later asks a similar question, the system can retrieve those vectors, so the feedback embedded in the stored pairs helps the model generate a more accurate response. This continuous cycle of feedback and re-storage keeps the vector database and the overall knowledge base fresh and highly relevant, improving the user experience and ensuring high accuracy. Additionally, once QA/QC pairs are verified (e.g., once a threshold amount of QA/QC pairs are verified), they are used to fine-tune the large-language-model, the embedding model, and/or the re-ranking model.

In examples disclosed herein, question-answer (QA) pairs are the primary data source for fine-tuning the large-language-model (LLM) because the LLM is used to generate an answer from a given question and context. By exposing the LLM to many QA pairs that have been verified as accurate, the model learns to produce reliable answers in future interactions.

By contrast, question-context (QC) pairs are used to fine-tune the embedding and re-ranking models. The embedding model converts text into numeric vectors that the system later compares to identify relevant passages, while the re-ranker refines the initial set of retrieved passages. Training these models with QC pairs (ach containing a question and the context that is used to answer that question), the models are fine-tuned (e.g., trained) based on which passages are most useful for answering specific types of questions, thereby improving the quality of the information fed to the LLM.

Other combinations of training data and/or target models are also possible. For example, one could use QA pairs to fine-tune the embedding model if the goal is to make the embeddings more semantically faithful. Additionally or alternatively QC pairs might be used to fine-tune the LLM if the focus is on incorporating contextual cues more effectively.

Fine-tuning may be triggered under a variety of conditions including, for example, when the accumulated number of QA and/or QC pairs surpasses a pre-set threshold, when a scheduled interval elapses (e.g., daily, weekly, bi-weekly, monthly, etc.), when the system detects that a sufficient amount of high-quality data has been gathered to warrant an update, or even at the manual request of a user and/or system administrator. In some examples, an evaluation step is used to confirm that the updated (e.g., fine-tuned) models meet or exceed a target accuracy before they are put into use in place of a prior model. This approach balances the need for up-to-date models with the computational cost of training, ensuring that each component is updated in line with the latest, most reliable data while keeping the overall system responsive and efficient. A variety of parameter-efficient techniques can be employed to fine-tune the models while keeping memory usage and computational cost low. One well-known approach for fine-tuning is Low-Rank Adaptation (LoRA), which injects small trainable matrices into a pre-trained model so that only a tiny fraction of the parameters are updated. An extension of LoRA that adds quantization is Quantized LoRA (QLoRA), and a further variant that incorporates quantization awareness during the adaptation process is Quantization-Aware Low-Rank Adaptation (QA-LoRA). Examples disclosed herein utilize QA-LoRA to illustrate the training process, but other fine-tuning and/or training techniques (such as full-fine-tuning, adapter-based methods, prompt-tuning, hyper-network augmentation, gradient-based parameter freezing, etc.) may additionally or alternatively be applied to the LLM, embedding, or re-ranker models in place of, or in addition to, QA-LoRA. QA-LoRA fine-tuning starts by taking a pre-trained language model (e.g., the existing model that is used to respond to user prompts) and converting weights of the model into a low-precision integer format (INT4). INT4 stores each weight as a 4-bit integer, which reduces the memory needed to keep the model and speeds up inference. Because INT4 reduces precision, the conversion is done with group-wise quantization. In other words, the model's weight matrix is split into many small, independent groups (e.g., 128 weights per group), and each group is scaled separately to preserve as much information as possible. The resulting quantized weight matrix is denoted W_quant.

Next, low-rank adapters (LoRA) are added to the linear layers of the model (for example, the attention blocks). An adapter includes two small matrices, A (the “input” adapter) and B (the “output” adapter), which are multiplied with the weight matrix. During fine-tuning, these two matrices are updated while the quantized base weights W_quant remain frozen. In examples disclosed herein, each element of A is constrained to have a same value within each quantization group, so that the adapter's parameters align with the group-wise structure introduced during quantization. This alignment allows the adapters to be trained (e.g., using stochastic gradient descent (SGD)) on task-specific data such as instruction-response pairs, while keeping the computational and memory demands very low.

After the adapter matrices (A and B) have been trained, QA-LoRA merges the adapter matrices directly into the quantized INT4 weight matrix using Equation 1, below:

$$W\_merged = W\_quant + s \cdot BA \qquad Equation 1$$

In equation 1, Wquant is the 4-bit integer representation of the base weights, and A and B are the low-rank adapter matrices that were inserted into each linear layer, and s is a scaling factor that normalizes the adapter update. Unlike QLoRA, which requires converting the INT4 model back to FP16 (16-bit floating-point format) for the merge and then re-quantizing (an extra step that can degrade accuracy), QA-LoRA keeps the merged weights natively in INT4, meaning no decompression to FP16 is performed. FP16 provides higher numerical precision than INT4 but consumes more memory and compute resources, so maintaining the model in INT4 throughout eliminates runtime dequantization overhead, improves inference speed by roughly 50%, and allows immediate deployment on edge devices, all while preserving near-FP16 accuracy.

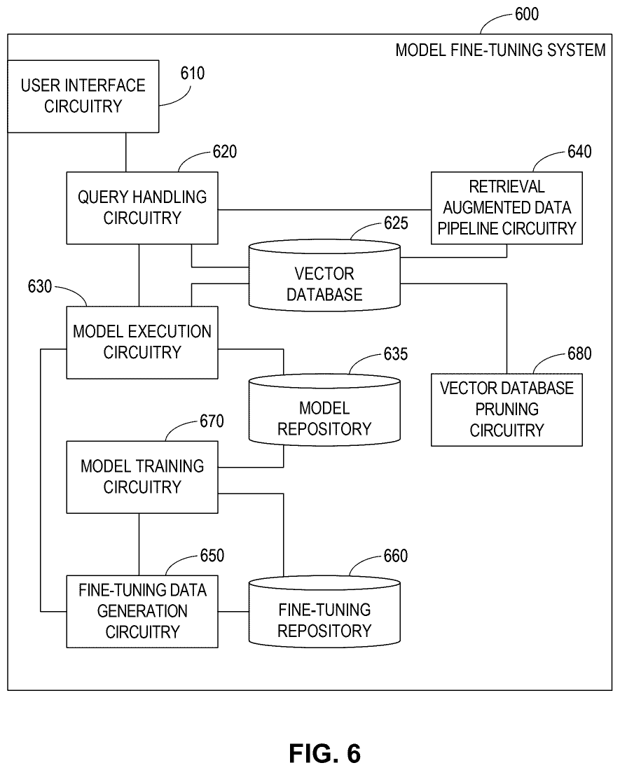

FIG. 6 is a block diagram of an example implementation of the model fine-tuning system 600 of FIG. 1 for jointly performing retrieval augmented generation and fine-tuning. The model fine-tuning system 600 of FIG. 6 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the model fine-tuning system 600 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 6 may be implemented by microprocessor circuitry executing instructions and/or FPGA circuitry performing operations to implement one or more virtual machines and/or containers.

The example model fine-tuning system 600 of the illustrated example of FIG. 6 includes user interface circuitry 610, query handling circuitry 620, a vector database 625, model execution circuitry 630, model repository 635, retrieval augmented generation pipeline circuitry 640, fine-tuning data generation circuitry 650, a fine-tuning data repository 660, model training circuitry 670, and vector database pruning circuitry 680.

The example user interface circuitry 610 of the illustrated example of FIG. 6 receives user input. The circuitry forwards input to the query handling circuitry 620. The circuitry obtains responses from the model execution circuitry 630. The circuitry renders responses on a display and/or provides information and/or instructions to cause rendering of a user interface on a display. The user interface circuitry 610 also collects user feedback. Feedback is provided to the fine-tuning data generation circuitry 650.

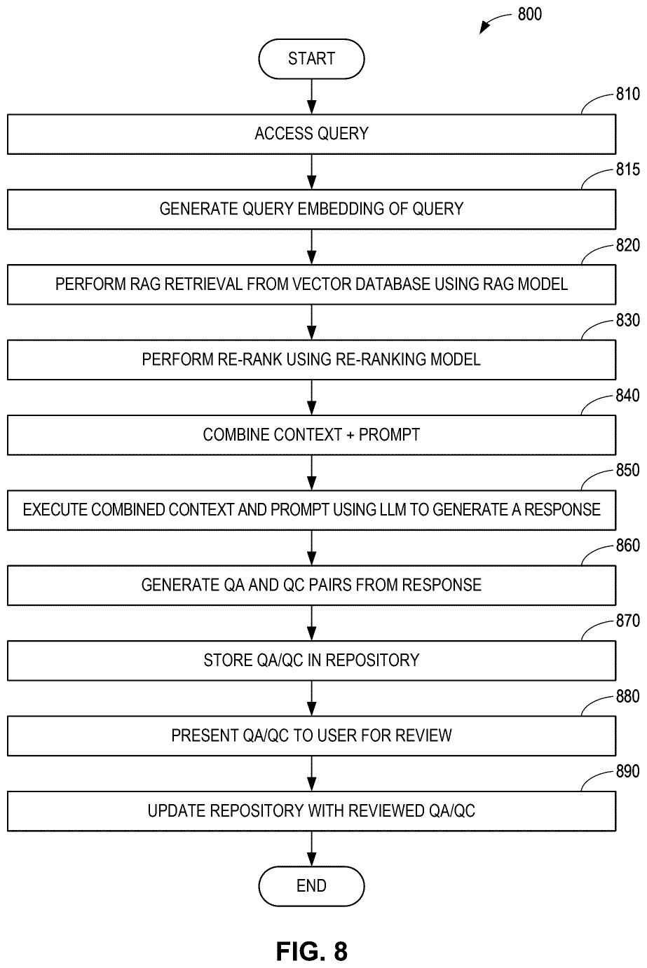

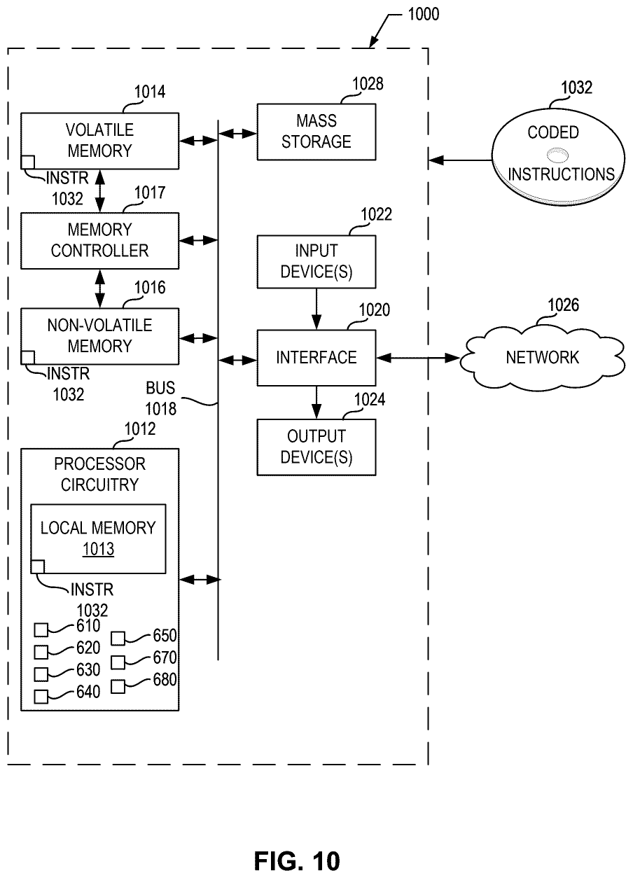

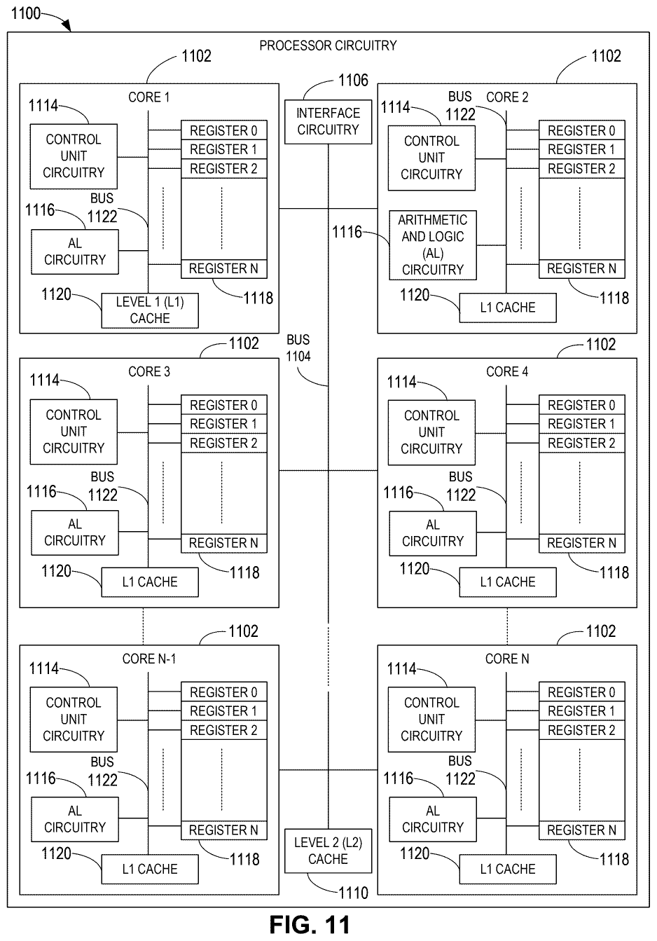

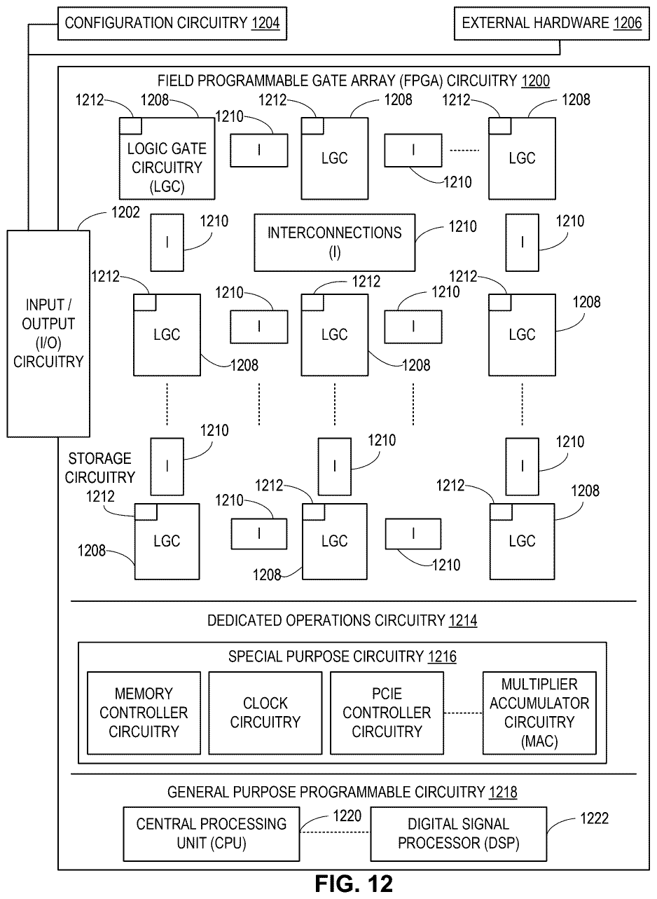

In some examples, the model fine-tuning system 600 includes means for interfacing with a user. For example, the means for interfacing with a user may be implemented by user interface circuitry 610. In some examples, the user interface circuitry 610 may be instantiated by programmable circuitry such as the example programmable circuitry 1012 of FIG. 10. For instance, the user interface circuitry 610 may be instantiated by the example microprocessor 1100 of FIG. 11 executing machine executable instructions such as those implemented by at least blocks 810, 880 of FIG. 8. In some examples, the user interface circuitry 610 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the user interface circuitry 610 may be instantiated by any other combination of hardware, software, and/or firmware. For example, the user interface circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The query handling circuitry 620 of the illustrated example of FIG. 6 accepts a user query supplied via the user interface circuitry 610. The query handling circuitry 620 uses an embedding model to generate a query embedding. The query handling circuitry 620 stores the query embedding in temporary memory and passes the embedding to the retrieval augmented generation pipeline circuitry 640. In some examples, the query handling circuitry 620 may also invoke guardrail checks before sending the query to the embedding model. The query handling circuitry 620 coordinates with the model execution circuitry 630 to trigger response generation once relevant documents have been retrieved and re-ranked via the RAG pipeline circuitry 640.

In some examples, the model fine-tuning system 600 includes means for handling a query. For example, the means for handling a query may be implemented by query handling circuitry 620. In some examples, the query handling circuitry 620 may be instantiated by programmable circuitry such as the example programmable circuitry 1012 of FIG. 10. For instance, the query handling circuitry 620 may be instantiated by the example microprocessor 1100 of FIG. 11 executing machine executable instructions such as those implemented by at least blocks 815, 840 of FIG. 8. In some examples, the query handling circuitry 620 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the query handling circuitry 620 may be instantiated by any other combination of hardware, software, and/or firmware. For example, the query handling circuitry 620 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example vector database 625 of the illustrated example of FIG. 6 is implemented by any memory, storage device and/or storage disc for storing data such as, for example, flash memory, magnetic media, optical media, solid state memory, hard drive(s), thumb drive(s), etc. Furthermore, the data stored in the example vector database 625 may be in any data format such as, for example, binary data, comma delimited data, tab delimited data, structured query language (SQL) structures, etc. While, in the illustrated example, the vector database 625 is illustrated as a single device, the example vector database 625 and/or any other data storage devices described herein may be implemented by any number and/or type(s) of memories. In the illustrated example of FIG. 6, the example vector database 625 stores vector embeddings of user documents, question context pairs, related metadata, etc. These vectors enable efficient similarity searches during retrieval augmented generation and provide the training data for fine-tuning of the embedding and re-ranker models. The vector database 625 supports pruning operations that remove entries when model accuracy thresholds are met. When smaller numbers of records are stored in the vector database 625, storage requirements are reduced, and retrieval performance is improved.

The example model execution circuitry 630 of the illustrated example of FIG. 6 causes execution of a machine learning model. The model execution circuitry 630 receives combined context and prompt data from the retrieval augmented generation pipeline circuitry 640. In the illustrated example of FIG. 6, the example model execution circuitry 630 is illustrated as a component of the model fine-tuning system 600. However, in some examples, the model execution circuitry 630 may be implemented separately from the model fine-tuning system 600. For example, the model execution circuitry 630 may be executed at a cloud computing platform or server having additional computational resources for execution of machine learning model(s). The model execution circuitry 630 supports both inference and fine-tuning operations when triggered by the model training circuitry 670. The model execution circuitry 630 interfaces with the model repository 635 to load and store updated model weights. In some examples, the model execution circuitry 630 can also output embeddings that are written to the vector database 625.

In some examples, the model fine-tuning system 600 includes means for executing a machine learning model. For example, the means for executing a machine learning model may be implemented by model execution circuitry 630. In some examples, the model execution circuitry 630 may be instantiated by programmable circuitry such as the example programmable circuitry 1012 of FIG. 10. For instance, the model execution circuitry 630 may be instantiated by the example microprocessor 1100 of FIG. 11 executing machine executable instructions such as those implemented by at least blocks 850 of FIG. 8. In some examples, the model execution circuitry 630 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the model execution circuitry 630 may be instantiated by any other combination of hardware, software, and/or firmware. For example, the model execution circuitry 630 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example retrieval augmented generation pipeline circuitry 640 of the illustrated example of FIG. 6 implements a multi-stage retrieval and generation workflow. The RAG pipeline circuitry 640 receives a user query and routes it to the embedding model, which generates a query embedding. The query embedding is sent to the vector database 625, which returns a set of candidate document embeddings and associated metadata. Candidate embeddings are forwarded to a re-ranking model, which assigns relevance scores and produces an ordered list of top-ranked documents (or portions of documents). The RAG pipeline circuitry 640 then assembles the query embedding, the top-ranked document snippets, and any system prompts into a composite input. This composite input is provided to the large language model, which generates a response. The RAG pipeline circuitry 640 captures the generated response and any QA or QC pairs produced by the model. The RAG pipeline circuitry 640 optionally forwards these QA/QC pairs to the fine-tuning data generation circuitry 650 for storage in the fine-tuning repository 660.

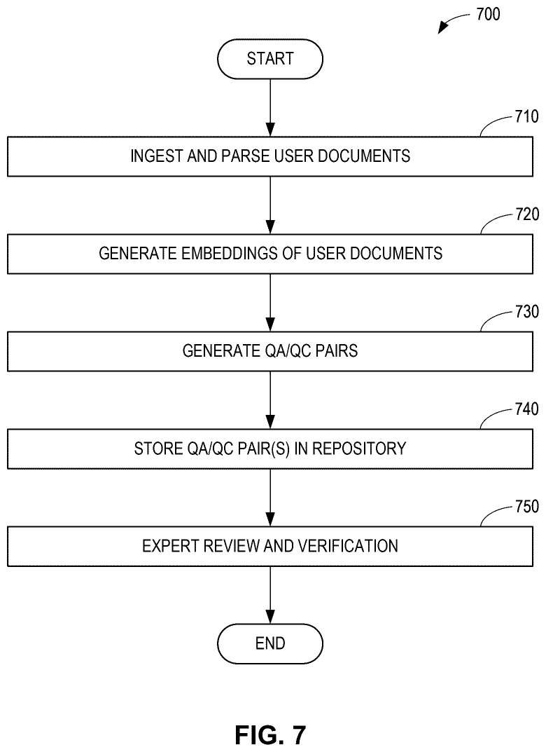

In some examples, the model fine-tuning system 600 includes means for performing retrieval augmented generation. For example, the means for performing retrieval augmented generation may be implemented by retrieval augmented generation pipeline circuitry 640. In some examples, the retrieval augmented generation pipeline circuitry 640 may be instantiated by programmable circuitry such as the example programmable circuitry 1012 of FIG. 10. For instance, the retrieval augmented generation pipeline circuitry 640 may be instantiated by the example microprocessor 1100 of FIG. 11 executing machine executable instructions such as those implemented by at least blocks 710, 720, 820, 830 of FIG. 7, 8. In some examples, the retrieval augmented generation pipeline circuitry 640 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the retrieval augmented generation pipeline circuitry 640 may be instantiated by any other combination of hardware, software, and/or firmware. For example, the retrieval augmented generation pipeline circuitry 640 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example model repository 635 of the illustrated example of FIG. 6 is implemented by any memory, storage device and/or storage disc for storing data such as, for example, flash memory, magnetic media, optical media, solid state memory, hard drive(s), thumb drive(s), etc. Furthermore, the data stored in the example model repository 635 may be in any data format such as, for example, binary data, comma delimited data, tab delimited data, structured query language (SQL) structures, etc. While, in the illustrated example, the model repository 635 is illustrated as a single device, the example model repository 635 and/or any other data storage devices described herein may be implemented by any number and/or type(s) of memories. In the illustrated example of FIG. 6, the example model repository 635 stores trained model and fine-tuned model data, including large language model weights, embedding model weights, and re-ranker model weights. In some examples, the example model repository 635 retains metadata describing each model version and associated performance metrics. During operation, the model repository 635 provides the RAG pipeline circuitry and the model training circuitry with access to current model weights, enabling model updates and efficient retrieval of updated models. The example model repository 635 functions as a central location for model management, supporting version control, rollback, and efficient loading of models into memory for inference or further fine-tuning.

The example fine-tuning data generation circuitry 650 of the illustrated example of FIG. 6 causes generation of fine-tuning data. The example fine-tuning data generation circuitry 650 receives QA and QC pairs from the RAG pipeline or from user feedback modules. The example fine-tuning data generation circuitry 650 parses each pair, extracts relevant context, and formats the data into a suitable training example. The circuitry may optionally annotate pairs with metadata such as confidence scores or source identifiers. The formatted examples are written into the fine-tuning data repository 660. The circuitry operates in conjunction with the model training circuitry 670 to trigger training when the number of collected examples reaches a defined threshold. The circuitry can be implemented with a microprocessor, memory, and logic circuits. The circuitry can be configured to use language model prompts to generate additional QA/QC pairs from documents. The circuitry supports both on-demand and periodic fine-tuning data generation.

In some examples, the model fine-tuning system 600 includes means for generating fine-tuning data. For example, the means for generating fine-tuning data may be implemented by fine-tuning data generation circuitry 650. In some examples, the fine-tuning data generation circuitry 650 may be instantiated by programmable circuitry such as the example programmable circuitry 1012 of FIG. 10. For instance, the fine-tuning data generation circuitry 650 may be instantiated by the example microprocessor 1100 of FIG. 11 executing machine executable instructions such as those implemented by at least blocks 730, 740, 750, 860, 870, 890 of FIG. 7, 8. In some examples, the fine-tuning data generation circuitry 650 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the fine-tuning data generation circuitry 650 may be instantiated by any other combination of hardware, software, and/or firmware. For example, the fine-tuning data generation circuitry 650 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example fine-tuning data repository 660 of the illustrated example of FIG. 6 is implemented by any memory, storage device and/or storage disc for storing data such as, for example, flash memory, magnetic media, optical media, solid state memory, hard drive(s), thumb drive(s), etc. Furthermore, the data stored in the example fine-tuning data repository 660 may be in any data format such as, for example, binary data, comma delimited data, tab delimited data, structured query language (SQL) structures, etc. While, in the illustrated example, the fine-tuning data repository 660 is illustrated as a single device, the example fine-tuning data repository 660 and/or any other data storage devices described herein may be implemented by any number and/or type(s) of memories. In the illustrated example of FIG. 6, the fine-tuning data repository 660 stores fine-tuning data including question-answer (QA) pairs, question-context (QC) pairs, and associated metadata such as timestamps, source identifiers, and version numbers. This fine-tuning data repository 660 serves as persistent storage for training data that feeds the fine-tuning circuitry 670, and can be accessed by the vector database pruning circuitry 680 when determining whether training data may be removed following model accuracy evaluation. The fine-tuning data repository 660 also supports indexing or tagging of stored data to enable efficient retrieval by the fine-tuning data generation circuitry 650 and the fine-tuning data repository 660.

The example model training circuitry 670 of the illustrated example of FIG. 6 performs fine-tuning of machine learning models. The example model training circuitry 670 accesses question-answer and question-context pairs stored in the fine-tuning data repository 660. The example model training circuitry 670 loads the base large language model, embedding model, and/or re-ranker model from the model repository 635 into local memory. The circuitry executes machine-readable instructions that configure a training environment, including parameter-efficient techniques such as LoRA, QLoRA, or QA-LoRA. The circuitry manages training iterations, monitors loss and accuracy metrics, and updates model parameters in memory. Upon completion of training, the circuitry writes the updated model back to the model repository 635. The circuitry also initiates evaluation of the fine-tuned model using a validation dataset and notifies the vector database pruning circuitry 680 when accuracy thresholds are satisfied.

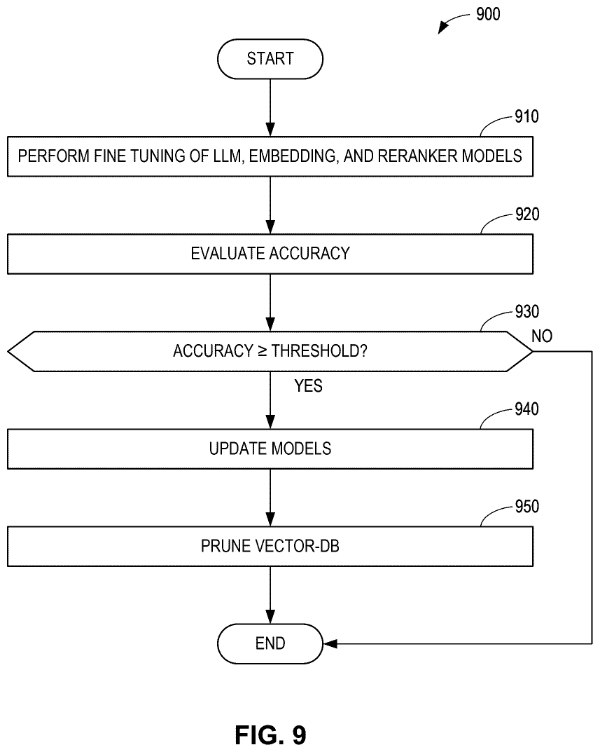

In some examples, the model fine-tuning system 600 includes means for fine-tuning a machine learning model. For example, the means for fine-tuning a machine learning model may be implemented by model training circuitry 670. In some examples, the model training circuitry 670 may be instantiated by programmable circuitry such as the example programmable circuitry 1012 of FIG. 10. For instance, the model training circuitry 670 may be instantiated by the example microprocessor 1100 of FIG. 11 executing machine executable instructions such as those implemented by at least blocks 910, 920, 930, 940 of FIG. 9. In some examples, the model training circuitry 670 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the model training circuitry 670 may be instantiated by any other combination of hardware, software, and/or firmware. For example, the model training circuitry 670 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The vector database pruning circuitry 680 of the illustrated example of FIG. 6 accesses accuracy metrics generated by the model training circuitry 670. Accuracy is evaluated by comparing the outputs of each fine-tuned component against a validation data set that includes QA and QC pairs that were withheld from training. For the large-language-model, accuracy may be measured with a simple exact-match metric, or a higher-order metric such as Bilingual Evaluation Understudy (BLEU) or Recall-Oriented Understudy for Gisting Evaluation (ROUGE) that quantifies how closely the generated answer matches an answer provided in the training data set. The embedding model may be evaluated with a retrieval-specific metric such as Mean Reciprocal Rank (MRR), which measures how often the correct passage appears in the top-k retrieved vectors. The re-ranker is assessed using one or more ranking metrics such as Mean Average Precision (MAP) to quantify how well the re-ranker orders the candidate passages. Each metric produces one or more scores, and a pre-defined accuracy threshold is set for each model.

The vector database pruning circuitry 680 compares the metrics to one or more predefined accuracy thresholds. When a metric exceeds the threshold, the vector database pruning circuitry 680 identifies the corresponding training data entries stored in the vector database. The vector database pruning circuitry 680 then issues deletion commands to the vector database storage to remove those entries. In some examples, the pruning operation may be selective. In other words, question-context (QC) pairs are removed when both embedding and re-ranker accuracies exceed the threshold, while question-answer (QA) pairs are removed when the large language model accuracy exceeds the threshold. The vector database pruning circuitry 680 may be implemented as a processor or logic block that performs lookups and deletion commands, and the vector database pruning circuitry 680 may update database metadata to reflect the new database size. This pruning functionality reduces the size of the vector database, accelerates retrieval operations, and conserves storage resources.

In some examples, the model fine-tuning system 600 includes means for pruning a vector database. For example, the means for pruning a vector database may be implemented by vector database pruning circuitry 680. In some examples, the vector database pruning circuitry 680 may be instantiated by programmable circuitry such as the example programmable circuitry 1012 of FIG. 10. For instance, the vector database pruning circuitry 680 may be instantiated by the example microprocessor 1100 of FIG. 11 executing machine executable instructions such as those implemented by at least blocks 950 of FIG. 9. In some examples, the vector database pruning circuitry 680 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the vector database pruning circuitry 680 may be instantiated by any other combination of hardware, software, and/or firmware. For example, the vector database pruning circuitry 680 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the model fine-tuning system 600 of FIG. 1 is illustrated in FIG. 6, one or more of the elements, processes, and/or devices illustrated in FIG. 6 may be combined, divided, re-arranged, omitted, eliminated, and/or implemented in any other way. Further, the example user interface circuitry 610, the example query handling circuitry 620, the example model execution circuitry 630, the example retrieval augmented generation pipeline circuitry 640, the example fine-tuning data generation circuitry 650, the example model training circuitry 670, the example vector database pruning circuitry 680, and/or, more generally, the example model fine-tuning system 600 of FIG. 6, may be implemented by hardware alone or by hardware in combination with software and/or firmware. Thus, for example, any of the example user interface circuitry 610, the example query handling circuitry 620, the example model execution circuitry 630, the example retrieval augmented generation pipeline circuitry 640, the example fine-tuning data generation circuitry 650, the example model training circuitry 670, the example vector database pruning circuitry 680, and/or, more generally, the example model fine-tuning system 600, could be implemented by programmable circuitry, such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine readable instructions (e.g., firmware or software). Further still, the example model fine-tuning system 600 of FIG. 6 may include one or more elements, processes, and/or devices in addition to, or instead of, those illustrated in FIG. 6, and/or may include more than one of any or all of the illustrated elements, processes and devices.

Flowchart(s) representative of example machine readable instructions, which may be executed by programmable circuitry to implement and/or instantiate the model fine-tuning system 600 of FIG. 6 and/or representative of example operations which may be performed by programmable circuitry to implement and/or instantiate the model fine-tuning system 600 of FIG. 6, are shown in FIGS. 7-9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-9, many other methods of implementing the example model fine-tuning system 600 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or an array of chiplets, etc.)). As used herein, programmable circuitry includes any type(s) of circuitry that may be programmed to perform a desired function such as, for example, a CPU, a core, a chiplet, an array of chiplets, a GPU, a VPU, and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more CPUs, one or more cores, one or more chiplets, one or more GPUs, one or more VPUs, and/or one or more FPGAs in a single machine, multiple CPUs, GPUs, VPUs, and/or FPGAs distributed across multiple servers of a server rack, and/or multiple CPUs, cores, chiplets, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 7-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations that may be executed, instantiated, and/or performed by programmable circuitry to facilitate the generation, storage, and refinement of question-answer (QA) and question-context (QC) pairs from user documents for a retrieval-augmented generation system.

At block 710, the retrieval augmented generation pipeline circuitry 640 ingests user documents and parses them into a structured format. The retrieval augmented generation pipeline circuitry 640 accesses raw documents provided via the user interface (or via another data location) and performs preprocessing steps such as tokenization, chunking, and metadata extraction.

At block 720, retrieval augmented generation pipeline circuitry 640 generates embeddings of user documents. The retrieval augmented generation pipeline circuitry 640 receives parsed user documents that have been stored in the vector database and invokes an embedding model to convert each document into a numerical vector representation. The resulting embeddings are stored back in the vector database, making them available for subsequent retrieval operations.

At block 730 of FIG. 7, the fine-tuning data generation circuitry 650 generates QA/QC pairs. In some examples, the generation of the QA/QC pairs involves submission of a prompt to the model execution circuitry 630. The fine-tuning data generation circuitry 650 receives the response from the model execution circuitry 630 and the retrieved documents that were supplied to the model in the preceding block. The example fine-tuning data generation circuitry 650 parses the model's output to identify candidate questions and corresponding answers, and extracts the relevant context from the retrieved documents. For each identified question, the fine-tuning data generation circuitry 650 produces a question-answer pair and, where applicable, a question-context pair. The generated pairs are then forwarded to the fine-tuning repository for subsequent use.

At block 740 of FIG. 7, the example fine-tuning data generation circuitry 650 stores QA/QC pairs in the fine-tuning repository 660. In this manner, the example fine-tuning data generation circuitry 650 ensures that the QA/QC pairs are retained in the fine-tuning repository 660 for subsequent fine-tuning processes.

At block 750, the example fine-tuning data generation circuitry 650 adjusts stored QA/QC pairs based on expert review and/or verification. The fine-tuning data generation circuitry 650 provides access to the stored QA/QC pairs (e.g., via the user interface circuitry 610) to facilitate review by a user (e.g., an expert, an administrator, an agent, etc.). Upon approval of a QA/QC pair, the example fine-tuning data generation circuitry 650 may cause storage of a record indicative of the validation status. If a QA/QC pair is rejected or corrected, the example fine-tuning data generation circuitry 650 removes or replaces the stored entry accordingly. This validation enables subsequent fine-tuning to benefit from the removal of incorrect and/or non-validated information.

FIG. 8 is a flowchart representative of example machine readable instructions and/or example operations that may be executed, instantiated, and/or performed by programmable circuitry to respond to a user query and generate QA and QC pairs for model fine-tuning. The example process 800 of FIG. 8 begins at block 810, where the example user interface circuitry 610 access a query. The query may originate from a user (e.g., a human user) or possibly from a non-human user (e.g., an agent). The example user interface circuitry 610 parses the query, verifies that the input conforms to expected syntax, and then makes the parsed query available to the subsequent query handling circuitry 620 for further processing.

At block 815, the example query handling circuitry 620 generates a query embedding of the query. The example query handling circuitry 620 receives the raw query text that entered through the user interface circuitry 610. The example query handling circuitry 620 normalizes the text, tokenizes it, and removes any stop words or irrelevant tokens. The example query handling circuitry 620 uses the embedding model 130 to produce a vector representation of the query.

At block 820, the example retrieval augmented generation pipeline circuitry 640 performs RAG retrieval from vector database using a RAG model. The example retrieval augmented generation pipeline circuitry 640 receives the query embedding generated at block 815. Using the RAG model, the example retrieval augmented generation pipeline circuitry 640 queries the vector database to retrieve a set of candidate documents.

At block 830 of FIG. 8, the example retrieval augmented generation pipeline circuitry 640 performs re-ranking of the candidate documents using a re-ranking model. The retrieval augmented generation pipeline circuitry 640 computes a relevance score for each candidate document, and then orders the candidates according to these scores, selects the top-ranked documents, and passes the reordered list of candidate documents for use in the context of the query to be processed. This re-ranking refines the retrieval results before they are combined with the user query and provided to the large language model.

At block 840 of FIG. 8, the example query handling circuitry 620 combines context and prompt. The query handling circuitry 620 accesses the retrieved context output from the retrieval augmented generation pipeline and the original user query. The query handling circuitry 620 then concatenates the context and query into a single prompt, inserting any required delimiters and/or prompt templates.

At block 850, the example model execution circuitry 630 causes execution of the combined context and prompt to generate a response. For example, a large language model may be used to processes the input and generate a natural-language response. In some examples, after generation of the response, the response may be provided to the user. However, the illustrated example of FIG. 8 continues to illustrate the generation of QA/QC pairs based on the generated response.

At block 860, the example fine-tuning data generation circuitry 650 generates QA and QC pairs from the response. The fine-tuning data generation circuitry 650 accesses the response produced by the model execution circuitry 630 and any relevant documents retrieved during the retrieval-augmented generation phase. The example fine-tuning data generation circuitry 650 parses the response to identify question-answer material and associated contextual passages. Using a pre-defined prompt or template, the circuitry produces a question, an answer derived from the response, and a context excerpt that supports the answer. In some examples, the QA and/or QC pairs are generated by causing the model execution circuitry 630 to execute a subsequent prompt and generate a QA/QC pair result.

At block 870, the example fine-tuning data generation circuitry 650 writes the QA and/or QC pair to the fine-tuning repository 660. At block 880, the example user interface circuitry 610 presents QA and/or QC pairs to the user for review. The example user interface circuitry 610 receives the QA and/or QC pairs from the fine-tuning data repository 660. The example user interface circuitry 610 formats the pairs for display on a screen or other output device. The example user interface circuitry 610 renders the pairs in a user-friendly layout and offers controls for approval or rejection. The example user interface circuitry 610 records the user's decision and forwards it to the fine-tuning data repository 660 for subsequent processing.

At block 890, the example fine-tuning data generation circuitry 650 updates the fine-tuning repository 660 based on the review performed by the user at block 880. Such update may include, for example, storing an indication that the QA and/or QC pair has been validated, deleting the QA and/or QC pair, applying an update to (e.g., a revision to the text of) the QA and/or QC pair. The updated fine-tuning repository 660 then becomes the source for subsequent fine-tuning of the machine-learning models.

FIG. 9 is a flowchart representative of example machine readable instructions and/or example operations that may be executed, instantiated, and/or performed by programmable circuitry to perform fine-tuning of a machine learning model based on QA & QC pairs. The flowchart illustrates a sequence of steps. The example process 900 of FIG. 9 begins at block 910, where the example model training circuitry 670 performs fine tuning of the large language model, the embedding model, and the re-ranker model. In some examples, this training process may be performed separately (e.g., the models may be trained individually). The example model training circuitry 670 first receives the QA and QC pairs stored in the fine-tuning repository. It then selects the appropriate fine-tuning method, such as LoRA or QA-LoRA, and applies the tuning procedure to each target model. In examples disclosed herein, QA pairs are used for fine-tuning of the LLM, while QC pairs are used for training the embedding model and the re-ranker model. During training, the example model training circuitry 670 monitors loss and accuracy metrics and stops training once a pre-defined convergence criterion is met. After training completes, the example model training circuitry 670 writes the updated model weights to the model repository 635.

At block 920, the example model training circuitry 670 evaluates an accuracy of the trained model(s). The example model training circuitry 670 receives the fine-tuned model(s) from the preceding fine-tuning step (910) and uses a validation dataset (e.g., based on QA and/or QC pairs). The example model training circuitry 670 applies the model(s) to the validation inputs, records the predicted outputs, and compares them with the reference outputs to compute an accuracy metric. In this manner, the updates to the three models (e.g., the LLM, the embedding model, and the re-ranker model) and the accuracy thereof, can be contemplated together.

At block 930, the example model training circuitry 670 determines whether the computed accuracy meets a pre-specified threshold. The circuitry receives an accuracy metric generated by the evaluation circuitry (from block 920). The accuracy metric is compared to a pre-defined threshold accuracy. If the accuracy metric meets or exceeds the accuracy threshold, control proceeds to block 940, where the example model training circuitry 670 updates the stored model(s), indicating that the stored models are ready for use. In some examples, the example model training circuitry 670 replaces the prior stored model(s) with the updated version(s). The example model training circuitry 670 records evaluation metrics to associate with the new model in the repository.

At block 950, the example vector database pruning circuitry 680 prunes embeddings from the vector database 625. The example vector database pruning circuitry 680 determines a list of embeddings that correspond to QA/QC pairs whose associated documents. The example vector database pruning circuitry 680 deletes those embeddings from the vector database 625, reducing database size and improving retrieval speed. If the accuracy of the fine-tuned model exceeds a predetermined threshold, the example vector database pruning circuitry 680 may optionally delete the entire set of embeddings associated with the selected QA/QC pairs. The flowchart of FIG. 9 then terminates, but may be re-executed periodically and/or a-periodically.

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

FIG. 10 is a block diagram of an example programmable circuitry platform 1000 structured to execute and/or instantiate the example machine-readable instructions and/or the example operations of FIGS. 7-9 to implement the model fine-tuning system 600 of FIG. 6. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, VPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example user interface circuitry 610, the example query handling circuitry 620, the example model execution circuitry 630, the example retrieval augmented generation pipeline circuitry 640, the example fine-tuning data generation circuitry 650, the example model training circuitry 670, the example vector database pruning circuitry 680.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 7-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7-9 to effectively instantiate the circuitry of FIG. 6 as logic circuits to perform operations corresponding to those machine readable instructions. In some such examples, the circuitry of FIG. 6 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-9. As such, the FPGA circuitry 1200 may be configured and/or structured to effectively instantiate some or all of the operations/functions corresponding to the machine readable instructions of the flowchart(s) of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIG. 6 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 6 may be implemented within one or more virtual machines and/or containers executing on the microprocessor 1100 of FIG. 11.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-9. As such, the FPGA circuitry 1200 may be configured and/or structured to effectively instantiate some or all of the operations/functions corresponding to the machine readable instructions of the flowchart(s) of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIG. 6 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 6 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

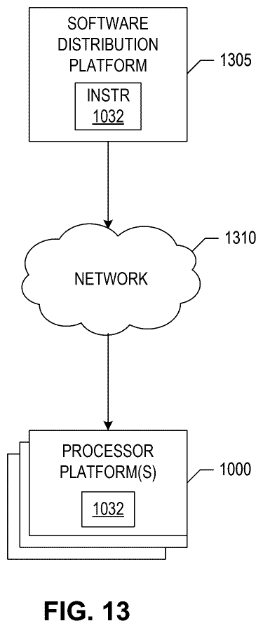

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 131305. For example, the software, which may correspond to the example machine readable instructions of FIG. 7-9, may be downloaded to the example programmable circuitry platform 1000, which is to execute the machine readable instructions 1032 to implement the model fine-tuning system 600. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Notwithstanding the foregoing, in the case of referencing a semiconductor device (e.g., a transistor), a semiconductor die containing a semiconductor device, and/or an integrated circuit (IC) package containing a semiconductor die during fabrication or manufacturing, “above” is not with reference to Earth, but instead is with reference to an underlying substrate on which relevant components are fabricated, assembled, mounted, supported, or otherwise provided. Thus, as used herein and unless otherwise stated or implied from the context, a first component within a semiconductor die (e.g., a transistor or other semiconductor device) is “above” a second component within the semiconductor die when the first component is farther away from a substrate (e.g., a semiconductor wafer) during fabrication/manufacturing than the second component on which the two components are fabricated or otherwise provided. Similarly, unless otherwise stated or implied from the context, a first component within an IC package (e.g., a semiconductor die) is “above” a second component within the IC package during fabrication when the first component is farther away from a printed circuit board (PCB) to which the IC package is to be mounted or attached. It is to be understood that semiconductor devices are often used in orientation different than their orientation during fabrication. Thus, when referring to a semiconductor device (e.g., a transistor), a semiconductor die containing a semiconductor device, and/or an integrated circuit (IC) package containing a semiconductor die during use, the definition of “above” in the preceding paragraph (i.e., the term “above” describes the relationship of two parts relative to Earth) will likely govern based on the usage context.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real-world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, chiplets that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed to perform retrieval augmented generation (RAG) jointly with fine-tuning of a large language model. Disclosed systems, apparatus, articles of manufacture, and methods improve the efficiency of using a computing device by automatically generating high-quality training data for fine-tuning, reducing the size of a vector database, and accelerating query response times. Examples disclosed herein also lower the computational cost of model updates by employing parameter-efficient fine-tuning techniques that keep the base model compact while preserving accuracy. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to system(s), method(s) and apparatus for jointly performing retrieval augmented generation and ai model fine-tuning are disclosed herein. Further examples and combinations thereof include the following:

Example 1 includes an apparatus, comprising interface circuitry, machine-readable instructions, and at least one processor circuit to be programmed by the machine-readable instructions to provide one or more documents to a machine learning model for generation of a response, the one or more documents stored in a vector database, generate a question-answer (QA) pair based on the response and the one or more documents, cause storage of the generated QA pair in a fine-tuning repository, initiate fine-tuning of the machine learning model using the QA pair stored in the fine-tuning repository, validate the fine-tuned model against a validation dataset, and after a determination that an accuracy of the fine-tuned model meets an accuracy threshold, remove the one or more documents from the vector database.

Example 2 includes the apparatus of example 1, wherein one or more of the at least one processor circuit is to convert a user query into an embedding, and to identify the one or more documents based on the embedding.

Example 3 includes the apparatus of example 2, wherein one or more of the at least one processor circuit is to fine-tune the embedding model based one or more question-context (QC) pairs.

Example 4 includes the apparatus of any one or more of examples 1-3, wherein one or more of the at least one processor circuit is to provide the generated QA pair to a user for approval, the fine-tuning performed based on an approved QA pair.

Example 5 includes the apparatus of any one or more of examples 1-4, wherein one or more of the at least one processor circuit is to cause execution of a re-ranker model as part of a retrieval augmented generation (RAG) pipeline to provide the one or more documents to the machine learning model.

Example 6 includes the apparatus of example 5, wherein one or more of the at least one processor circuit is to fine-tune the re-ranker model based one or more question-context (QC) pairs.

Example 7 includes the apparatus of any one or more of examples 1-6, wherein one or more of the at least one processor circuit is to generate the QA pair by causing execution of a QA pair generation prompt with the machine learning model.

Example 8 includes the apparatus of claim 1, wherein to fine-tune the machine-learning model, one or more of the at least one processor circuit is to convert the pre-trained model weights to 4-bit integer format (INT4) through group-wise quantization to produce a quantized weight matrix, insert low-rank adapter matrices into a layer of the model, train the low-rank adapter matrices on task-specific data while keeping the quantized weight matrix frozen, and merge the trained adapters into the quantized weights.

Example 9 includes the apparatus of claim 8, wherein to merge the trained adapters, one or more of the at least one processor circuit is to: compute a scaling factor that normalizes the trained adapter matrices, add the scaled product to the frozen quantized weight matrix, and store the resulting merged weight in INT4 format without conversion to a floating point format.

Example 10 includes at least one non-transitory machine-readable medium comprising machine-readable instructions to cause at least one processor circuit to at least provide one or more documents to a machine learning model for generation of a response, the one or more documents stored in a vector database, generate a question-answer (QA) pair based on the response and one or more documents, cause storage of the generated QA pair in a fine-tuning repository, initiate fine-tuning of the machine learning model using the QA pair stored in the fine-tuning repository, validate the fine-tuned model against a validation dataset, and after a determination that an accuracy of the fine-tuned model meets an accuracy threshold, remove the one or more documents from the vector database.

Example 11 includes the at least one non-transitory machine-readable medium of example 10, wherein the machine-readable instructions are to cause one or more of the at least one processor circuit to convert a user query into an embedding using an embedding model, and to identify the one or more documents based on the embedding.

Example 12 includes the at least one non-transitory machine-readable medium of example 11, wherein the machine-readable instructions are to cause one or more of the at least one processor circuit to fine-tune the embedding model based one or more question-context (QC) pairs.

Example 13 includes the apparatus of any one or more of examples 10-12, wherein the machine-readable instructions are to cause one or more of the at least one processor circuit to provide the generated QA pair to a user for approval, the fine-tuning performed based on an approved QA pair.

Example 14 includes the apparatus of any one or more of examples 10-13, wherein the machine-readable instructions are to cause one or more of the at least one processor circuit to cause execution of a re-ranker model as part of a retrieval augmented generation (RAG) pipeline to provide the one or more documents to the machine learning model.

Example 15 includes the at least one non-transitory machine-readable medium of example 14, wherein the machine-readable instructions are to cause one or more of the at least one processor circuit to fine-tune the re-ranker model based one or more question-context (QC) pairs.

Example 16 includes the apparatus of any one or more of examples 10-15, wherein the machine-readable instructions are to cause one or more of the at least one processor circuit to generate the QA pair by causing execution of a QA pair generation prompt using the machine learning model.

Example 17 includes an apparatus for fine-tuning a machine learning model, the apparatus comprising means for performing retrieval augmented generation to provide one or more documents to a machine learning model for generation of a response, the one or more documents stored in a vector database, means for generating fine-tuning data to generate a question-answer (QA) pair based on the response and one or more documents, the means for generating to cause storage of the generated QA pair in a fine-tuning repository, means for fine-tuning to initiate fine-tuning of the machine learning model using the QA pair stored in the fine-tuning repository, the means for fine-tuning to validate the fine-tuned model against a validation dataset, and means for pruning to remove, after a determination that an accuracy of the fine-tuned model meets an accuracy threshold, the one or more documents from the vector database.

Example 18 includes the apparatus of example 17, wherein the means for generating is to convert a user query into an embedding using an embedding model, the embedding to be used to identify the one or more documents.

Example 19 includes the apparatus of example 18, wherein the means for fine-tuning is to train the embedding model based one or more question-context (QC) pairs.

Example 20 includes the apparatus of any one or more of examples 17-19, including means for interacting with a user to provide the generated QA pair to a user for approval, the fine-tuning to be performed based on an approved QA pair.

Example 21 includes the apparatus of any one or more of examples 17-20, wherein the means for interacting is to cause execution of a re-ranker model as part of a retrieval augmented generation (RAG) pipeline.

Example 22 includes the apparatus of example 21, wherein the means for fine-tuning is to train the re-ranker model based one or more question-context (QC) pairs.

Example 23 includes a method for fine-tuning a machine learning model, the method comprising providing one or more documents to a machine learning model for generation of a response, the one or more documents stored in a vector database, generating a question-answer (QA) pair based on the response and one or more documents, storing the generated QA pair in a fine-tuning repository, initiating fine-tuning of the machine learning model using the QA pair stored in the fine-tuning repository, validating the fine-tuned model against a validation dataset, and removing, after a determination that an accuracy of the fine-tuned model meets an accuracy threshold, the one or more documents from the vector database.

Example 24 includes the method of example 23, wherein the generating of the QA pair includes converting a user query into an embedding using an embedding model, and the method includes using the embedding to identify the one or more documents.

Example 25 includes the method of example 24, wherein the fine-tuning is further to train the embedding model based one or more question-context (QC) pairs.

Example 26 includes the method of any one or more of examples 23-25, including providing the generated QA pair to a user for approval, wherein the fine-tuning is performed based on an approved QA pair.

Example 27 includes the method of any one or more of examples 23-26, wherein the providing of the one or more documents to the machine learning model includes causing execution of a re-ranker model as part of a retrieval augmented generation (RAG) pipeline.

Example 28 includes the method of example 27, wherein the fine-tuning is further to train the re-ranker model based one or more question-context (QC) pairs.

Example 29 includes the method of any one or more of examples 23-28, wherein the QA pair is generated by causing execution of a QA pair generation prompt using the machine learning model.

Example 30 includes machine-readable storage including machine-readable instructions, when executed, to implement a method or realize an apparatus as claimed in any preceding example.

Example 31 includes an apparatus comprising means to perform any method of examples 23-29.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

We claim:

1. An apparatus, comprising:
interface circuitry;
machine-readable instructions; and
at least one processor circuit to be programmed by the machine-readable instructions to:
provide one or more documents to a machine learning model for generation of a response, the one or more documents stored in a vector database;
generate a question-answer (QA) pair based on the response and the one or more documents;
cause storage of the generated QA pair in a fine-tuning repository;
initiate fine-tuning of the machine learning model using the QA pair stored in the fine-tuning repository;
validate the fine-tuned model against a validation dataset; and
after a determination that an accuracy of the fine-tuned model meets an accuracy threshold, remove the one or more documents from the vector database.

2. The apparatus of claim 1, wherein one or more of the at least one processor circuit is to convert a user query into an embedding, and to identify the one or more documents based on the embedding.

3. The apparatus of claim 2, wherein one or more of the at least one processor circuit is to fine-tune the embedding model based one or more question-context (QC) pairs.

4. The apparatus of claim 1, wherein one or more of the at least one processor circuit is to provide the generated QA pair to a user for approval, the fine-tuning performed based on an approved QA pair.

5. The apparatus of claim 1, wherein one or more of the at least one processor circuit is to cause execution of a re-ranker model as part of a retrieval augmented generation (RAG) pipeline to provide the one or more documents to the machine learning model.

6. The apparatus of claim 5, wherein one or more of the at least one processor circuit is to fine-tune the re-ranker model based one or more question-context (QC) pairs.

7. The apparatus of claim 1, wherein one or more of the at least one processor circuit is to generate the QA pair by causing execution of a QA pair generation prompt with the machine learning model.

8. The apparatus of claim 1, wherein to fine-tune the machine-learning model, one or more of the at least one processor circuit is to:
convert the pre-trained model weights to 4-bit integer format (INT4) through group-wise quantization to produce a quantized weight matrix;
insert low-rank adapter matrices into a layer of the model;
train the low-rank adapter matrices on task-specific data while keeping the quantized weight matrix frozen; and
merge the trained adapters into the quantized weights.

9. The apparatus of claim 8, wherein to merge the trained adapters, one or more of the at least one processor circuit is to: compute a scaling factor that normalizes the trained adapter matrices, add the scaled product to the frozen quantized weight matrix, and store the resulting merged weight in INT4 format without conversion to a floating point format.

10. At least one non-transitory machine-readable medium comprising machine-readable instructions to cause at least one processor circuit to at least:
provide one or more documents to a machine learning model for generation of a response, the one or more documents stored in a vector database;
generate a question-answer (QA) pair based on the response and one or more documents;
cause storage of the generated QA pair in a fine-tuning repository;
initiate fine-tuning of the machine learning model using the QA pair stored in the fine-tuning repository;
validate the fine-tuned model against a validation dataset; and
after a determination that an accuracy of the fine-tuned model meets an accuracy threshold, remove the one or more documents from the vector database.

11. The at least one non-transitory machine-readable medium of claim 10, wherein the machine-readable instructions are to cause one or more of the at least one processor circuit to convert a user query into an embedding using an embedding model, and to identify the one or more documents based on the embedding.

12. The at least one non-transitory machine-readable medium of claim 11, wherein the machine-readable instructions are to cause one or more of the at least one processor circuit to fine-tune the embedding model based one or more question-context (QC) pairs.

13. The at least one non-transitory machine-readable medium of claim 10, wherein the machine-readable instructions are to cause one or more of the at least one processor circuit to provide the generated QA pair to a user for approval, the fine-tuning performed based on an approved QA pair.

14. The at least one non-transitory machine-readable medium of claim 10, wherein the machine-readable instructions are to cause one or more of the at least one processor circuit to cause execution of a re-ranker model as part of a retrieval augmented generation (RAG) pipeline to provide the one or more documents to the machine learning model.

15. The at least one non-transitory machine-readable medium of claim 14, wherein the machine-readable instructions are to cause one or more of the at least one processor circuit to fine-tune the re-ranker model based one or more question-context (QC) pairs.

16. The at least one non-transitory machine-readable medium of claim 10, wherein the machine-readable instructions are to cause one or more of the at least one processor circuit to generate the QA pair by causing execution of a QA pair generation prompt using the machine learning model.

17. An apparatus for fine-tuning a machine learning model, the apparatus comprising:
means for performing retrieval augmented generation to provide one or more documents to a machine learning model for generation of a response, the one or more documents stored in a vector database;
means for generating fine-tuning data to generate a question-answer (QA) pair based on the response and one or more documents, the means for generating to cause storage of the generated QA pair in a fine-tuning repository;
means for fine-tuning to initiate fine-tuning of the machine learning model using the QA pair stored in the fine-tuning repository, the means for fine-tuning to validate the fine-tuned model against a validation dataset; and
means for pruning to remove, after a determination that an accuracy of the fine-tuned model meets an accuracy threshold, the one or more documents from the vector database.

18. The apparatus of claim 17, wherein the means for generating is to convert a user query into an embedding using an embedding model, the embedding to be used to identify the one or more documents.

19. The apparatus of claim 18, wherein the means for fine-tuning is to train the embedding model based one or more question-context (QC) pairs.

20. The apparatus of claim 17, including means for interacting with a user to provide the generated QA pair to a user for approval, the fine-tuning to be performed based on an approved QA pair.
